(19) United States
(12) Patent Application Publication
(10) Pub. No.: US 2020/0387470 A1
(43) Pub. Date: Dec. 10, 2020

(54) PCI EXPRESS CHAIN DESCRIPTORS

(71) Applicant: Intel Corporation, Santa Clara, CA (US)

(72) Inventors: Bo Cui, Shanghai (CN); Peng Shu, Shanghai (CN)

(73) Assignee: Intel Corporation, Santa Clara, CA (US)

(21) Appl. No.: 16/958,685

(22) PCT Filed: Mar. 30, 2018
(86) PCT No.: PCT/CN2018/081335

§ 371 Date: Jun. 27, 2020

(51) Int. Cl. G06F 13/42; G06F 13/16; G06F 13/20; G06F 9/4401; G06F 9/54; G06F 21/44; G06F 21/85

(52) U.S. Cl. CPC G06F 13/4221; G06F 13/1642; G06F 13/20; G06F 2213/0026; G06F 9/546; G06F 21/44; G06F 21/85; G06F 9/4411

(57) ABSTRACT

There is disclosed a computing apparatus, including: a hardware platform; an interface to a computer expansion bus; logic configured to operate on the hardware platform to: provision an unshaded memory queue, including a dedicated memory window for the computer expansion bus; and provision a descriptor ring, the descriptor ring configured to receive a descriptor, identify the descriptor as a chain descriptor targeted to a descriptor chain, identify a general descriptor unit (GDU) of the chain descriptor as having a device identifier (DID) matching the computing apparatus, process a workload of the GDU according to a private data field of the GDU, and forward the chain descriptor to a next-hop device via a switch fabric of the computer expansion bus, including bypassing a root complex of the computer expansion bus.

### FIELD OF THE SPECIFICATION

This disclosure relates in general to the field of electronic interconnects, and more particularly, though not exclusively, to a system and method for providing peripheral component interconnect express (PCIe) chain descriptors.

### BACKGROUND

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers may require higher performance, while the mobile ecosystem is sometimes able to sacrifice overall performance for power savings. Yet, a singular purpose of most fabrics is to provide the highest possible performance with maximum power saving.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates a number of components that may be implemented in offloading a cipher operation for network acceleration, according to one or more examples of the present specification.

FIG. 2 is a block diagram of a system using vertical peripheral component interconnect express (PCIe) communication, according to one or more examples of the present specification.

FIG. 3 is a block diagram of a host device which communicates with a plurality of endpoints via a PCIe bus, according to one or more examples of the present specification.

FIG. 4 is a block diagram of a chain descriptor, according to one or more examples of the present specification.

FIG. 5 is a block diagram of a plurality of generalized descriptor units (GDUs) that may be found for example in a chain descriptor, according to one or more examples of the present specification.

FIG. 6 illustrates a software flow, according to one or more examples of the present specification.

FIGS. 7A-7B are a flowchart of a hardware flow that may be performed for example by the endpoint devices themselves, in response to receiving a chain descriptor, according to one or more examples of the present specification.

FIG. 8 illustrates an embodiment of a fabric composed of point-to-point links that interconnect a set of components, according to one or more examples of the present specification.

FIG. 9 illustrates an embodiment of a layered protocol stack, according to one or more embodiments of the present specification.

FIG. 10 illustrates an embodiment of a PCIe transaction descriptor, according to one or more examples of the present specification.

FIG. 11 illustrates an embodiment of a PCIe serial point-to-point fabric, according to one or more examples of the present specification.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily implied by any embodiment.

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice the present embodiments. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present disclosure.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, system on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

Embodiments of the present specification may be provided on a hardware platform, by way of nonlimiting example. Hardware platforms may be or comprise a rack or several racks of blade or slot servers (including, e.g., processors, memory, and storage), one or more data centers, other hardware resources distributed across one or more geographic locations, hardware switches, or network interfaces.

In a high performance computing cluster, a data center, a high-end workstation, a server, or even in a desktop or a handheld device, it is often desirable to offload certain functions to dedicated hardware, firmware, or even software accelerator devices rather than consume processing power on those tasks. For example, graphics accelerators, or graphical processing units (GPUs) have been used for decades to render and output graphics to a video monitor without burdening the system's central processing unit (CPU).

In the case of servers and data centers, network interface cards (NICs) may have access to certain accelerators that not only free up CPU resources, but that, because they can be implemented in hardware, for example in an application-specific integrated circuit (ASIC) or in a field-programmable gate array (FPGA), may be able to perform a task much more quickly than a CPU. Thus, in high throughput systems, specialized hardware accelerators may be used for compression, decompression, encryption, decryption, deep packet inspection, or other processes that can affect a network flow.

In a more general sense, the teachings of the present specification can be applied broadly to any accelerator device that may be coupled to a host device to aid the host device in performing its function.

Many current solutions provide SoC-based solutions that hardwire multiple intellectual property (IP) blocks together to achieve high throughput. Other solutions, including some solutions employed by Intel® Corporation employ high-speed buses, such as a peripheral component interconnect express (PCIe) bus to integrate multiple devices into a common platform. In some cases, direct memory access (DMA) like features may be provided via PCIe. In those cases, the application may be responsible for accessing and managing the various accelerator devices that may be available.

Consider, for example, a case where a host system operates in conjunction with a cryptographic accelerator and a compression accelerator to assist a network interface card in providing high throughput packet processing.

Existing PCIe solutions may work vertically with discrete software drivers for each subsystem to move data between the various components and the upper-level application. For example, consider the case where the NIC, the crypto accelerator, and the compression accelerator all communicate with a host device via a PCIe bus. In a vertical configuration, an incoming packet may hit the NIC, and be processed by the NIC, which then communicates with the host device via the PCIe root complex. The host device may recognize that the packet is both compressed and encrypted, and may first send the packet to a decryption accelerator via the PCIe root complex. The decryption accelerator returns the decrypted but still compressed packet to the host via the PCIe root complex, and the host device then finally sends the packet to the decompression accelerator via the PCIe root complex. The decompression accelerator decompresses the packet and returns the uncompressed packet to the host device via the PCIe root complex.

This interchange of data includes a plurality of vertical transactions on the PCIe bus via the PCIe root complex. This plurality of vertical transactions can result in substantial overhead in processing a packet.

Some existing systems solve the cost of vertical transactions by integrating devices inline. This may include, for example, adding crypto, switching, FPGA, DPI, and other components together inline on an SoC to boost performance efficiency. For example, an FPGA-based smart NIC may include encryption, quality of service processing, and storage acceleration, all offloaded from the CPU. In such smart NIC SoC solutions, the flexibility to design systems is limited. This is particularly true in cases where the SoC is a single silicon device, that must be manufactured and fabricated with all of the overhead of that process. This leads to a long development cycle and delays in keeping up with the pace of diverse scaling of workloads in a data center.

In contrast, embodiments of the present specification leverage existing endpoint-to-endpoint communications capabilities in the PCIe bus by introducing a chain descriptor among a string of devices that operate together, similar to a service chain. Using the chain descriptor of the present specification, a workload can be transferred to the next device in the chain via the PCIe bus without passing through the PCIe root complex. Instead, each device in the chain examines the chain descriptor for a matching workload, and if one is found, the device operates on the payload and performs its task. The accelerator device then inspects the chain descriptor for a next device in the chain, and if a next device exists, it passes the payload to the next device. When the last device in the chain has performed its function, the resulting and possibly modified payload may be returned to the write queue of the “header device” (in other words, the first device in the chain) which can then return the workload to the host device via the root complex as though the header device had performed the entire chain of work itself. This can substantially reduce the host input/output (I/O) burden for high-performance packet processing workloads, and can be scaled up to include even more devices, such as discrete graphics cards, FPGA acceleration cards, digital signal processors (DSPs), network processing units (NPUs), and similar, without overhead escalation.

A system and method for providing PCIe chain descriptors will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

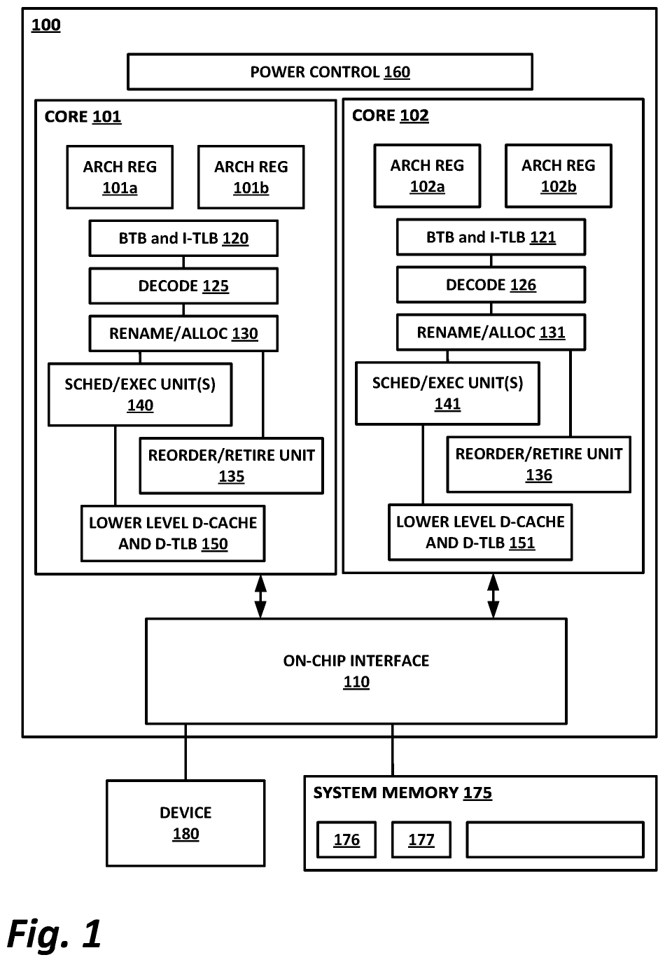

FIG. 1 illustrates a number of components that may be implemented in offloading a cipher operation for network acceleration, according to one or more examples of the present specification. The disclosed architecture of FIG. 1 may be provided in some embodiments with the PCIe chain descriptors of the present specification, and may benefit therefrom.

Processor 100 includes any processor or processing device, such as a microprocessor, an embedded processor, a digital signal processor (DSP), a network processor, a handheld processor, an application processor, a coprocessor, an SoC, or other device to execute code. Processor 100, in one embodiment, includes at least two cores—core 101 and 102, which may include asymmetric cores or symmetric cores (the illustrated embodiment). However, processor 100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores—cores 101 and 102. Here, cores 101 and 102 are considered symmetric cores (i.e., cores with the same configurations, functional units, and/or logic). In another embodiment, core 101 includes an out-of-order processor core, while core 102 includes an in-order processor core. However, cores 101 and 102 may be individually selected from any type of core, such as a native core, a software managed core, a core adapted to execute a native instruction set architecture (ISA), a core adapted to execute a translated instruction set architecture (ISA), a co-designed core, or other known core. In a heterogeneous core environment (i.e., asymmetric cores), some form of translation, such as binary translation, may be utilized to schedule or execute code on one or both cores. Yet to further the discussion, the functional units illustrated in core 101 are described in further detail below, as the units in core 102 operate in a similar manner in the depicted embodiment.

As depicted, core 101 includes two hardware threads 101a and 101b, which may also be referred to as hardware thread slots 101a and 101b. Therefore, software entities, such as an operating system, in one embodiment potentially view processor 100 as four separate processors, i.e., four logical processors or processing elements capable of executing four software threads concurrently. As alluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In core 101, other smaller resources, such as instruction pointers and renaming logic in allocator and renamer block 130 may also be replicated for threads 101a and 101b. Some resources, such as re-order buffers in reorder/retirement unit 135, instruction translation lookaside buffer (I-TLB) 120, load/store buffers, and queues may be shared through partitioning. Other resources, such as general purpose internal registers, page-table base register(s), low-level data-cache and data translation lookaside buffer (D-TLB) 150, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 125 coupled to fetch unit 120 to decode fetched elements. Fetch logic, in one embodiment, includes individual sequencers associated with thread slots 101a and 101b, respectively. Usually core 101 is associated with a first ISA, which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below, in one embodiment decoders 125 include logic designed or adapted to recognize specific instructions, such as a transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 126, in one embodiment, recognize the same ISA (or a subset thereof). Alternatively, in a heterogeneous core environment, decoders 126 recognize a second ISA (either a subset of the first ISA or a distinct ISA).

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operations on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache, such as a second level cache associated with on-chip interface 110. Note that higher-level or further-out refers to cache levels increasing or getting further way from the execution unit(s). In one embodiment, higher-level cache is a last-level data cache−last cache in the memory hierarchy on processor 100—such as a second or third level data cache. However, higher level cache is not so limited, as it may be associated with or include an instruction cache. A trace cache—a type of instruction cache—instead may be coupled with decoder 125 to store recently decoded traces. Here, an instruction potentially refers to a macro-instruction (i.e., a general instruction recognized by the decoders), which may decode into a number of micro-instructions (micro-operations).

In the depicted configuration, processor 100 also includes on-chip interface module 110. Historically, a memory controller, which is described in more detail below, has been included in a computing system external to processor 100. In this scenario, on-chip interface 110 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include dynamic random access memory (DRAM), static random access memory (SRAM), non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SoC, each of these devices may be incorporated on processor 100. For example, in one embodiment, a memory controller hub is on the same package and/or die with processor 100. Here, a portion of the core (an on-core portion) 110 includes one or more controller(s) for interfacing with other devices such as memory 175 or a graphics device 180. The configuration including an interconnect and controllers for interfacing with such devices is often referred to as an on-core (or “uncore”) configuration. As an example, on-chip interface 110 includes a ring interconnect for on-chip communication and a high-speed serial point-to-point link 105 for off-chip communication. Yet, in the SoC environment, even more devices, such as the network interface, coprocesors, memory 175, graphics processor 180, and any other known computer devices/interfaces may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform high-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e., generally where syntactic processing, semantic processing, and some transformation/optimization may take place, and (2) a back-end, i.e., generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

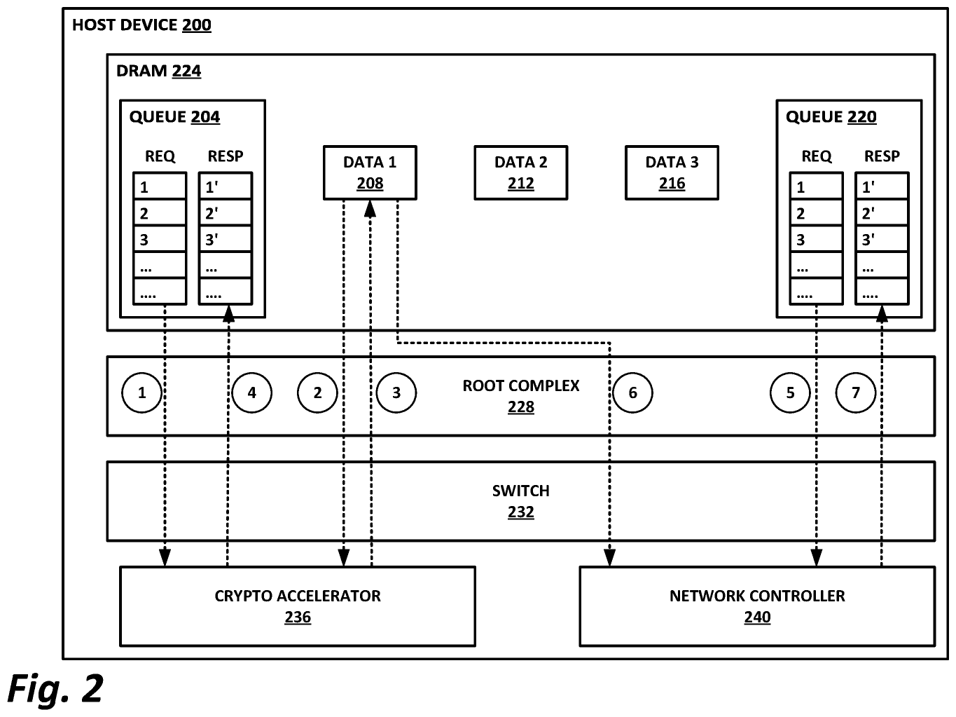

FIG. 2 is a block diagram of a system using vertical peripheral component interconnect express (PCIe) communication, according to one or more examples of the present specification.

FIG. 2 illustrates a host device 200 including a memory such as DRAM 224. Host device may be, for example, a security gateway according to embodiments of the present specification. DRAM 224 has defined therein queues 204 and 220. Further contained within DRAM 224 are data blocks 208, 212, and 216. Host device 200 also includes a PCIe root complex 228, a PCIe switch 232, a crypto accelerator 236, and a network controller 240.

The operations provided in this accelerator cipher transaction can be read in conjunction with table 1 below.

| | Type | From | To | Initiator |
|---|---|---|---|---|
| 1 | Descriptor | DRAM | Accelerator | Accelerator |
| 2 | Data | DRAM | Accelerator | Accelerator |
| 3 | Data | Accelerator | DRAM | Accelerator |
| 4 | Descriptor | Accelerator | DRAM | Accelerator |
| 5 | Descriptor | DRAM | NIC | NIC |
| 6 | Data | DRAM | NIC | NIC |
| 7 | Descriptor | NIC | DRAM | NIC |

At operation 1, a descriptor is sent via PICe root complex 228 from queue 204 of DRAM 224 to crypto accelerator 236.

At operation 2, crypto accelerator 236 retrieves data 1 208 from DRAM 224 via PCIe root complex 228.

At operation 3, crypto accelerator 236 returns data 1 208 to DRAM 224 via PCIe root complex 228.

At operation 4, crypto accelerator 236 returns a descriptor to queue 204 of DRAM 224 via PCIe root complex 228. This indicates to DRAM 224 that crypto accelerator 236 has completed its transaction.

At operation 5, DRAM 224, now operating queue 220, sends a descriptor to network controller 240 via PCIe root complex 228.

At operation 6, network controller 240 retrieves data 1, which may have already been modified by crypto accelerator 236, from DRAM 224 via PCIe root complex 228.

At operation 7, network controller 240 may perform a network operation, such as sending the packet out over the network. Network controller 240 then returns a descriptor to queue 220 of DRAM 224 via PCIe root complex 228.

As illustrated in this FIGURE, application centralized management of the PCIe flow allows flexibility to combine devices with various schemes, but it escalates the transaction overhead on the PCIe bus. For example, in the case of a security gateway, three data transactions are needed on the ingress side to manage the payload when using an accelerator to offload cipher operations. Two extraneous transfers are also added for crypto accelerator 236, thus introducing a 200% bus overhead for this single device.

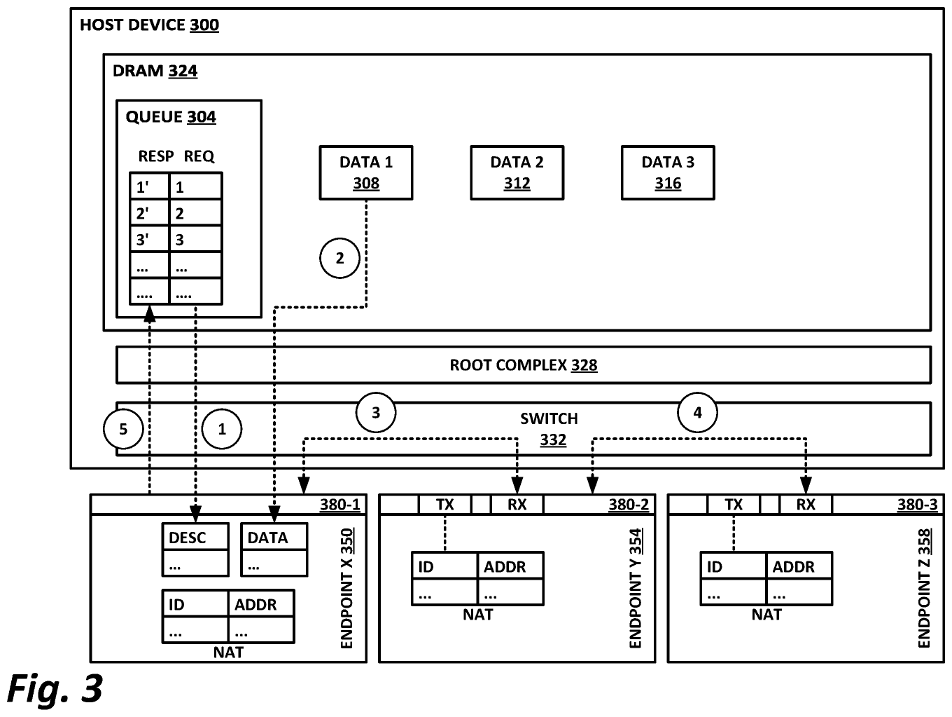

FIG. 3 is a block diagram of a host device 300 which communicates with a plurality of endpoints, namely endpoint X 350, endpoint Y 354, and endpoint Z 358 via a PCIe bus, according to one or more examples of the present specification.

Similar to FIG. 2, host device 300 includes DRAM 324 with a queue 304 including request and response queues. DRAM 324 includes data 1 308, data 2 312, and data 3 316.

Host device 300 includes PCIe root complex 328, and PCIe switch 332. Also connected to PCIe switch 332 are endpoint X 350, endpoint Y 354, and endpoint Z 358.

Embodiments of the present specification may employ the switch forwarding capabilities of PCIe switch 332 to enable endpoint devices to communicate with peers, thus alleviating the overhead burden on PCIe root complex 328. This provides beneficial high throughput and high performance data processing. This can be realized using a chain descriptor of the present specification to link multiple PCIe devices together as a service. Data may then be manipulated and forwarded to neighbors based on a sequence defined in the control block of the descriptor.

Host device 300 may include a software framework that integrates all of the vertical drivers for the endpoint devices together and defines a descriptor schema, including multiple control blocks. Each driver sets up its private block in the schema for its corresponding device, while constructing a chain request, such as a security association of a crypto accelerator, or a virtual local area network (VLAN) tag of a network interface.

After all sections of the chain descriptor are filled in, the chain descriptor is pushed into the request ring of the header device (in this case, endpoint X 350) which is the first device and the descriptor chain. Endpoint X 350, acting as the header device can then start data processing, which can then be propagated to endpoints Y 354 and endpoint Z 358.

Once endpoint Z 358 has finished its work, the result may be propagated back to the response ring of endpoint X 350, which acts as the header device in the chain.

For example, at operation 1, DRAM 324 pushes a chain descriptor out to endpoint X 350 via PCIe root complex 328.

At operation 2, endpoint X 350, acting as the header device in the chain, retrieves data 1 308 from DRAM 324. Endpoint X 350 then performs its function on data 1 308.

However, instead of sending a response descriptor back to queue 304, at operation 3, endpoint X 350 inspects the chain descriptor, and determines that endpoint Y 354 is the next device in the chain. Endpoint X 350 then pushes the data and the chain descriptor to endpoint Y 354 via PCIe switch 332, without traversing root complex 328. Endpoint Y 354 then performs its action on data 1 308.

After completing its function, at operation 4, endpoint Y 354 pushes the chain descriptor and data 1 308 out to endpoint Z 358. Endpoint Z 358 then performs its function on data 1 308. Endpoint Z 358 can now return data 1 308 and the chain descriptor to endpoint X 350 via PCIe switch 332 without traversing PCIe root complex 328.

Finally, at operation 5, endpoint X 350 pushes a response descriptor to response queue 304, indicating that the chain of services is complete. Host device 300 can then continue to operate on data 1 308.

In contrast to existing descriptors, in chain mode, each endpoint device handles only its private portion of the descriptor, and does so with a procedure similar to legacy handling of descriptors.

If a next device is available in the chain, the processed data are not returned to an address in DRAM 324, but instead are written to an “unshaded queue” residing in the next device. An unshaded queue is a PCIe memory region implemented in the endpoint to receive memory write transactions from other endpoint devices. This may include a descriptor window and a payload window. The endpoint driver may initialize and export those windows to the software framework after kernel PCIe enumeration is complete.

Also illustrated in this embodiment, a system-level neighborhood address table (NAT) may include mapping of device ID and queue windows. This NAT may be constructed and downloaded to chain devices after the service chain is set up. To forward a chain descriptor or data, an endpoint may look up the on-chip NAT to get the queue address of the next device, then carry the descriptor and payload to those devices through memory write transactions to the unshaded queue of the next device.

In some embodiments, limitations may be added to the chain descriptor to improve security.

In one example, this may include configuration of isolation between functions. Function configuration may be isolated through dedicated base address registers (BARs), to prevent malicious configuration among different virtual functions.

To prevent malicious construction of a device chain, the device chain deployment may be set through a NAT, which may be programmed in a trusted environment, such as a device kernel driver managed by a privileged user.

Configuration of the NAT by an untrusted end user, such as a virtual function or physical function (PF) user space driver may be directed and managed by a centralized host kernel driver.

To prevent malicious construction of a descriptor, for multiple applications running on the same device, the endpoint may perform a runtime check for the current and next pointer inside the descriptor to validate the device ID for the next endpoint device (for example, a Bus:Device.Funtion notation, or BDF). Only a descriptor consistent with the loaded NAT entry may be forwarded. Otherwise, the request may be dropped and an error may be returned.

Embodiments of the chain descriptor disclosed herein are compatible with virtualization, with little to no impact on existing virtualization deployments. Endpoints supporting single root input/output virtualization (SR-IOV) can be exposed as multiple functions, although they may be functions in the same domain (i.e., host or guest) in order to be chained together. The header device of the chain is the only device that needs to interact with the input/output memory management unit (IOMMU) to fetch the payload from DRAM. Data movement among the chain is accomplished in a peer-to-peer manner, without involving the PCIe root complex or the device DRAM. DMA remapping may be utilized for the header device, but is not required for down-chain devices. Other tasks of the virtual function, such as interrupt requests (IRQs) or errors may be handled according to existing techniques.

Note that the teachings of the present specification are compatible with next-generation virtualization technologies such as shared virtual memory (SVM) and SR-IOV.

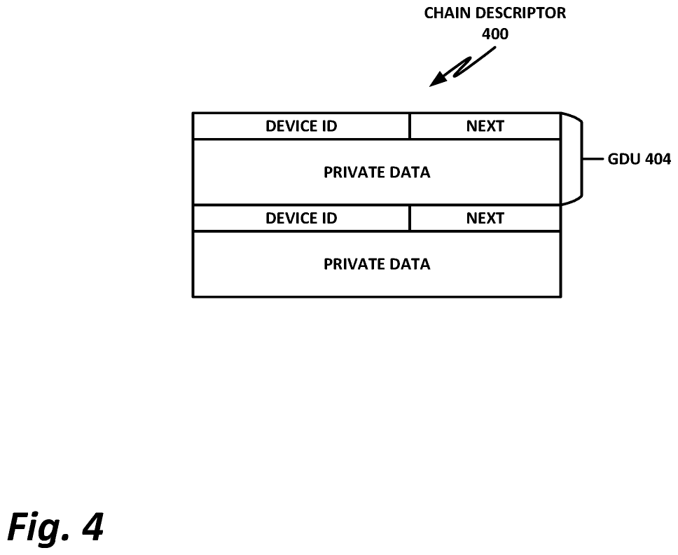

FIG. 4 is a block diagram of a chain descriptor 400, according to one or more examples of the present specification.

Chain descriptor 400 may be a flexible structure dynamically constructed by an application or driver based on a workload scheme. A chain descriptor 400 may include a plurality of general descriptor units (GDUs), with a GDU for each device, and the GDUs linked in a sequence.

By way of nonlimiting example, a GDU 404 may include at least the following three fields:
Device ID (DID), also known as the target ID or BDF. This is the ID of the device that is to handle this particular GDU within chain descriptor 400. When a device receives chain descriptor 400 it finds the DID that matches itself, and processes only that GDU. It can then send the rest of chain descriptor 400 to the next device in the chain. The device may return an error if the received DID is not a match.
Next is an offset of the next GDU. This allows the device to locate the next GDU and forward the remainder of chain descriptor 400 to the next hop in the descriptor chain. A null value in the Next field indicates that this is the last device in the chain.
Private data may include any data or structures that are used in existing descriptors for PCIe workloads. For example, this may be LAN packet control information for a NIC, or a security association of a crypto accelerator by way of nonlimiting and illustrative example.

An application employing a descriptor chain according to the teachings of the present specification constructs chain descriptor 400 and sends chain descriptor 400 to the first, or header, device in the chain. The endpoint devices can then pass chain descriptor 400 via a PCIe switch without going through the PCIe root complex. Once all devices are finished performing their functions, a descriptor can be returned to the response ring of the header device. The header device can then return a descriptor to the host device via the PCIe root complex indicating that work on the payload has been completed.

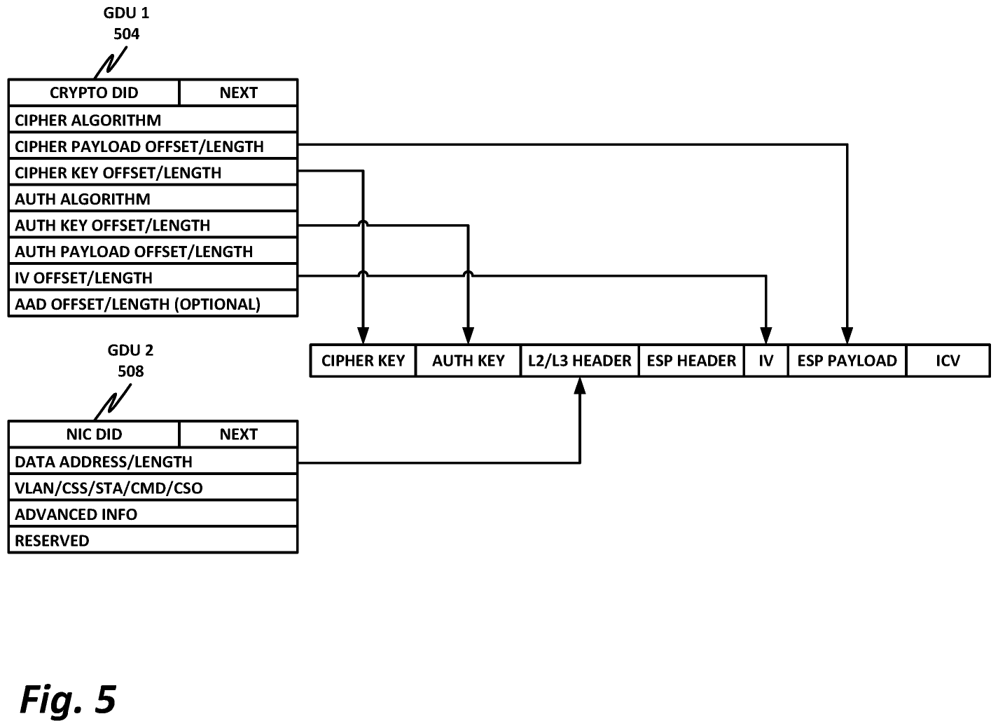

FIG. 5 is a block diagram of a plurality of generalized descriptor units (GDUs), namely GDU 1 504 and GDU 2 508, that may be found for example in a chain descriptor, according to one or more examples of the present specification.

This example illustrates a case where a chain descriptor is used for a departing Ethernet packet on a crypto accelerator-enhanced computing platform.

The crypto accelerator driver may set GDU 1 504, including the cipher/off attributes and related payload information.

The network controller driver may construct GDU 2 508 from the same payload, including Ethernet attributes. GDU 2 508 can then be appended to GDU 1 504. These two GDUs combined can form a chain descriptor. Note that in some embodiments, a chain descriptor may also include other data, such as framing data or a header. However, these are not necessarily required, and in some cases, the chain descriptor can consist entirely of a chain of individual GDUs.

While the two GDUs, GDU 1 504 and GDU 2 508, refer to the same payload, control bits within the Private data segment of the GDUs may be used to indicate how the devices handle the requests, respectively.

To support the novel descriptors of the present specification, hardware in the endpoint devices may be improved to support the chain mode. These may include, by way of nonlimiting example, a discrete descriptor ring to support the GDU layout. The device ring can be set as either a legacy mode (e.g., targeting only one device), or a chain mode (targeting a set of devices).

The endpoint device may also include a dedicated PCIe memory window for neighbor device access. These unshaded queue addresses may be applied to the neighbor devices before a chain service is started. After inlet request processing is finished, it may be forwarded to the next address in the neighborhood address table (NAT) if the NAT lookup succeeds.

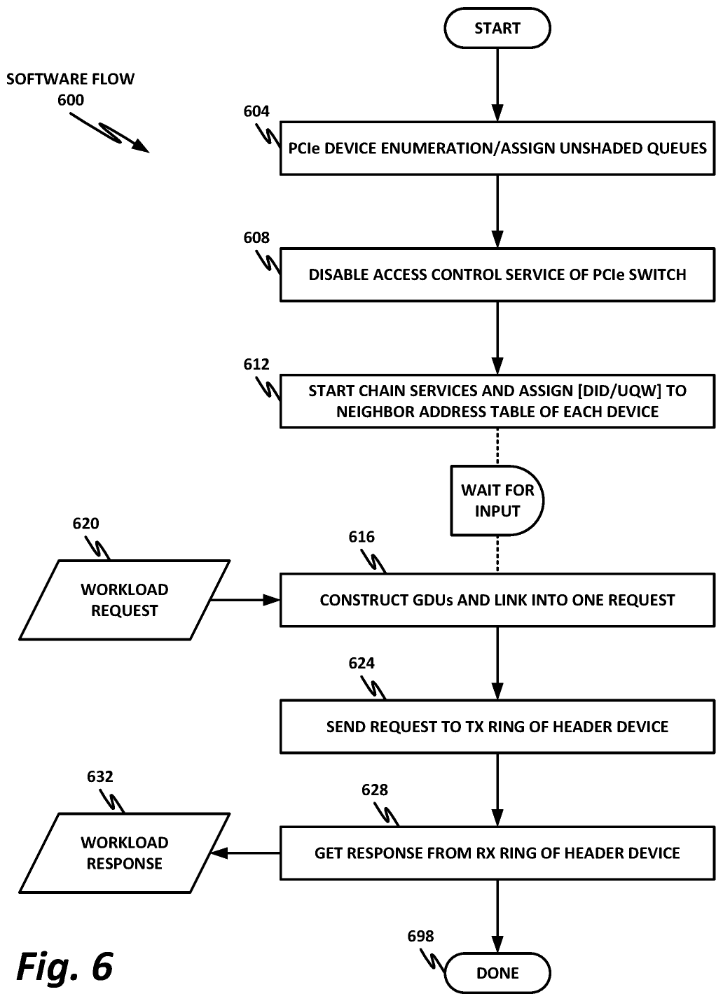

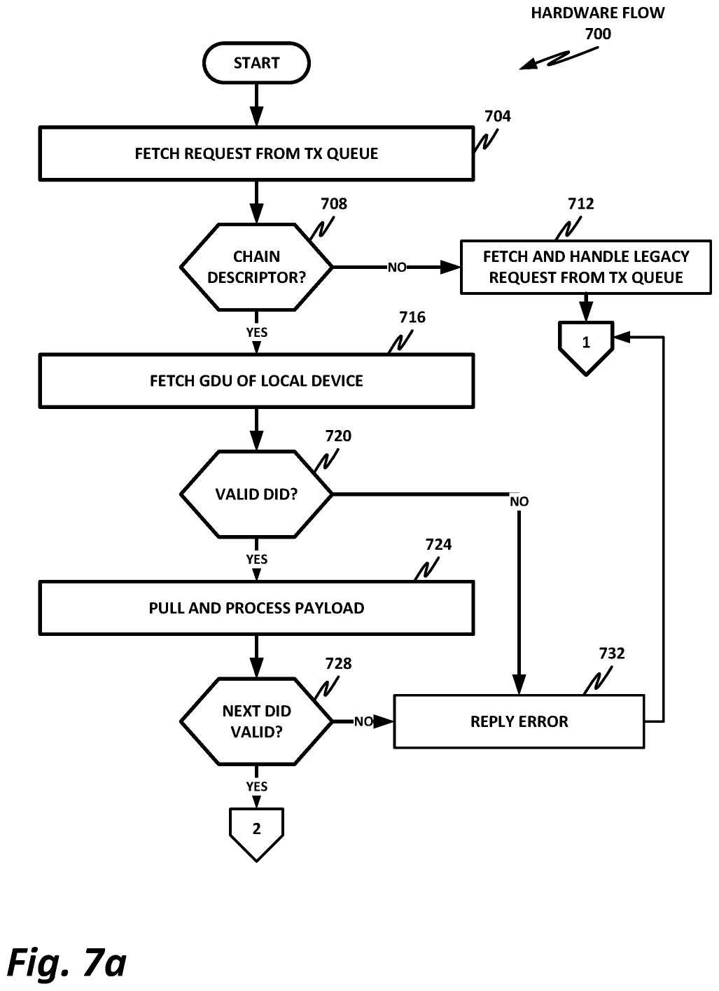

Hardware and software flows are shown in FIGS. 6, 7A, and 7B, respectively. During an initialization phase, the software may need to configure a NAT for all devices so that payloads can be forwarded among devices after local processing is done.

FIG. 6 illustrates software flow 600, according to one or more examples of the present specification.

Starting in block 604, the host device performs PCIe device enumeration, and can then assign unshaded queue windows (UQWs). As disclosed in the present specification, an unshaded queue is a PCIe memory region implemented in the endpoint to receive memory write transactions from other endpoint devices. Examples of unshaded windows, which may include a descriptor window and a payload window, are illustrated in FIG. 3, such as unshaded windows 380-1, 380-2, and 380-3.

In block 608, the software may disable access control services on the PCIe switch.

In block 612, the software starts a chain service, including assigning a DID/UQW to the NAT for each device.

The software then waits for an appropriate input.

In block 616, the software receives workload request 620. Responsive to workload request 620, the software constructs the GDUs for the chain descriptor, and links them into one request, as illustrated in FIGS. 4 and 5.

In block 624, the software sends the request, including the chain descriptor, to the transmit ring of the header device in the descriptor chain.

In block 628, after all of the devices have finished performing their function on the workload, the software gets the response from the receive ring of the header device. The software can then export workload response 632 to the appropriate software flow.

In block 698, the method is done.

FIGS. 7A-7B are a flowchart chart of a hardware flow 700 that may be performed for example by the endpoint devices themselves, in response to receiving a chain descriptor, according to one or more examples of the present specification.

In block 704, the header device fetches the request from its transmit queue.

In decision block 708, the device determines whether the current descriptor is a chain descriptor.

In block 712, if the descriptor is not a chain descriptor, then in block 712, the device fetches and handles the legacy request from the transmit queue according to known methods. Following off-page connector 1 to FIG. 7B, at block 798, the method is done.

Returning to block 708 of FIG. 7A, if the present descriptor is a chain descriptor, then in block 716, the device finds the GDU that matches the local device.

In decision block 720, the device determines whether the present DID is a valid DID for this device. If the DID is not a valid DID, then in block 732, the device replies with an error. Again following off-page connector 1 to FIG. 7B, in block 798, the method is done.

Returning to decision block 720, if the present DID is a valid DID, then in block 724, the device pulls the payload from DRAM into the device on-chip memory. The device then processes the payload based on the private data in the GDU.

In decision block 728, the device checks to determine whether the next DID is a valid DID. If the next DID is not valid, then again in block 732, the device replies with an error, and following off-page connector 1 to FIG. 7B, in block 798, the method is done.

Returning to decision block 728, if the next DID in the chain is a valid DID, then following off-page connector 2 to FIG. 7B, at block 736 the device looks up the next device in the NAT.

In block 740, the device writes the descriptor and payload into the neighbor device queue of the next device in the chain.

In block 744, the device waits to receive a response 742 into its response queue. When the device receives the response 742 in its response queue and determines that the response is not null, then the device checks in block 748 to determine whether the next DID is a valid DID.

If the next DID is not valid, then the device determines that it is the header device, and in block 756, the device writes the response to the response ring in DRAM.

If the next DID is valid, then in block 752, the device performs a NAT lookup and writes the response to its neighbor device.

In block 752, the method is done.

One interconnect fabric architecture includes the PCIe architecture. A primary goal of PCIe is to enable components and devices from different vendors to inter-operate in an open architecture, spanning multiple market segments, clients (desktops and mobile), servers (standard and enterprise), and embedded and communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power management, quality of service (QoS), hot-plug/hot-swap support, data integrity, and error handling are among some of the advanced features supported by PCI Express.

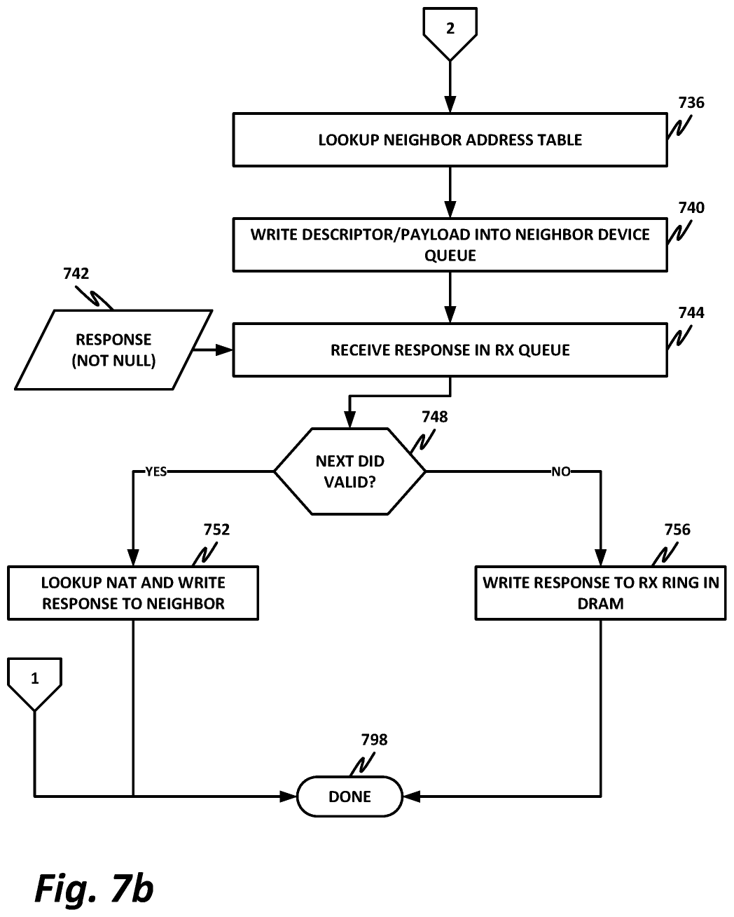

FIG. 8 illustrates an embodiment of a fabric composed of point-to-point links that interconnect a set of components, according to one or more examples of the present specification. The disclosed architecture of FIG. 8 may be provided in some embodiments with the PCIe chain descriptors of the present specification, and may benefit therefrom.

System 800 includes processor 805 and system memory 810 coupled to controller hub 815. Processor 805 includes any processing element, such as a microprocessor, a host processor, an embedded processor, a coprocessor, or other processor. Processor 805 is coupled to controller hub 815 through front-side bus (FSB) 806. In one embodiment, FSB 806 is a serial point-to-point interconnect as described below. In another embodiment, link 806 includes a serial, differential interconnect architecture that is compliant with differential interconnect standards.

System memory 810 includes any memory device, such as random access memory (RAM), non-volatile (NV) memory, or other memory accessible by devices in system 800. System memory 810 is coupled to controller hub 815 through memory interface 816. Examples of a memory interface include a double-data rate (DDR) memory interface, a dual-channel DDR memory interface, and a dynamic RAM (DRAM) memory interface.

In one embodiment, controller hub 815 is a root hub, root complex, or root controller in a Peripheral Component Interconnect Express (PCIe) interconnection hierarchy. Examples of controller hub 815 include a chipset, a memory controller hub (MCH), a northbridge, an interconnect controller hub (ICH) a southbridge, and a root controller/hub. Often the term chipset refers to two physically separate controller hubs, i.e., a memory controller hub (MCH) coupled to an interconnect controller hub (ICH). Note that current systems often include the MCH integrated with processor 805, while controller 815 is to communicate with I/O devices, in a similar manner as described below. In some embodiments, peer-to-peer routing is optionally supported through root complex 815.

Here, controller hub 815 is coupled to switch/bridge 820 through serial link 819. Input/output modules 817 and 821, which may also be referred to as interfaces/ports 817 and 821, include/implement a layered protocol stack to provide communication between controller hub 815 and switch 820. In one embodiment, multiple devices are capable of being coupled to switch 820.

Switch/bridge 820 routes packets/messages from device 825 upstream, i.e., up a hierarchy towards a root complex, to controller hub 815 and downstream, i.e., down a hierarchy away from a root controller, from processor 805 or system memory 810 to device 825. Switch 820, in one embodiment, is referred to as a logical assembly of multiple virtual PCI-to-PCI bridge devices. Device 825 includes any internal or external device or component to be coupled to an electronic system, such as an I/O device, a network interface controller (NIC), an add-in card, an audio processor, a network processor, a hard-drive, a storage device, a CD/DVD ROM, a monitor, a printer, a mouse, a keyboard, a router, a portable storage device, a Firewire device, a universal serial bus (USB) device, a scanner, and other input/output devices. Often in the PCIe vernacular, such as device is referred to as an endpoint. Although not specifically shown, device 825 may include a PCIe to PCl/PCI-X bridge to support legacy or other-version PCI devices. Endpoint devices in PCIe are often classified as legacy, PCIe, or root complex integrated endpoints.

Graphics accelerator 830 is also coupled to controller hub 815 through serial link 832. In one embodiment, graphics accelerator 830 is coupled to an MCH, which is coupled to an ICH. Switch 820, and accordingly I/O device 825, is then coupled to the ICH. I/O modules 831 and 818 are also to implement a layered protocol stack to communicate between graphics accelerator 830 and controller hub 815. Similar to the MCH discussion above, a graphics controller or the graphics accelerator 830 itself may be integrated in processor 805.

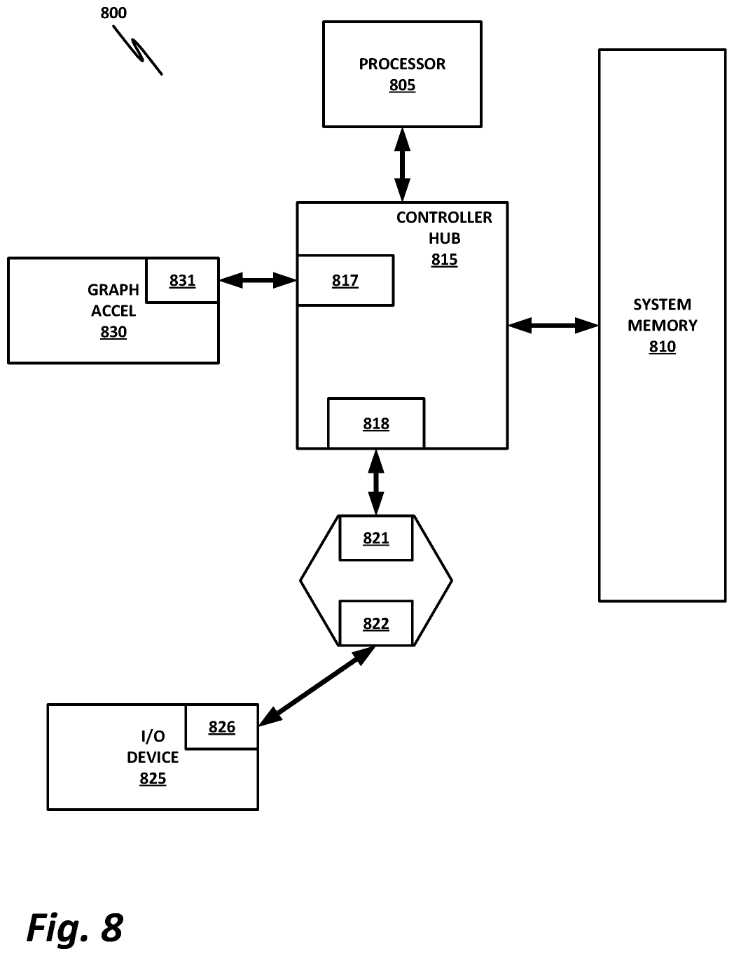

FIG. 9 illustrates an embodiment of a layered protocol stack, according to one or more embodiments of the present specification. The disclosed architecture of FIG. 9 may be provided in some embodiments with the PCIe chain descriptors of the present specification, and may benefit therefrom.

Layered protocol stack 900 includes any form of a layered communication stack, such as a Quick Path Interconnect (QPI) stack, a PCie stack, a next generation high performance computing interconnect stack, or other layered stack.

Although the discussion immediately below in reference to FIGS. 8-11 is presented in relation to a PCIe stack, the same concepts may be applied to other interconnect stacks. In one embodiment, protocol stack 900 is a PCIe protocol stack including transaction layer 905, link layer 910, and physical layer 920. An interface, such as interfaces 817, 818, 821, 822, 826, and 831 in FIG. 8, may be represented as communication protocol stack 900. Representation as a communication protocol stack may also be referred to as a module or interface implementing/including a protocol stack.

PCIe uses packets to communicate information between components. Packets are formed in the transaction layer 905 and data link layer 910 to carry the information from the transmitting component to the receiving component. As the transmitted packets flow through the other layers, they are extended with additional information to handle packets at those layers. At the receiving side the reverse process occurs and packets get transformed from their physical layer 920 representation to the data link layer 910 representation and finally (for transaction layer packets) to the form that can be processed by the transaction layer 905 of the receiving device.

Transaction Layer

In one embodiment, transaction layer 905 is to provide an interface between a device's processing core and the interconnect architecture, such as data link layer 910 and physical layer 920. In this regard, a primary responsibility of the transaction layer 905 is the assembly and disassembly of packets, i.e., transaction layer packets (TLPs). The translation layer 905 typically manages credit-based flow control for TLPs. PCIe implements split transactions, i.e., transactions with request and response separated by time, allowing a link to carry other traffic while the target device gathers data for the response.

In addition, PCIe utilizes credit-based flow control. In this scheme, a device advertises an initial amount of credit for each of the receive buffers in transaction layer 905. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more read requests and write requests to transfer data to/from a memory-mapped location. In one embodiment, memory space transactions are capable of using two different address formats, e.g., a short address format, such as a 32-bit address, or a long address format, such as a 64-bit address. Configuration space transactions are used to access configuration space of the PCIe devices. Transactions to the configuration space include read requests and write requests. Message space transactions (or, simply messages) are defined to support in-band communication between PCIe agents.

Therefore, in one embodiment, transaction layer 905 assembles packet header/payload 906. Format for current packet headers/payloads may be found in the PCIe specification at the PCIe specification website.

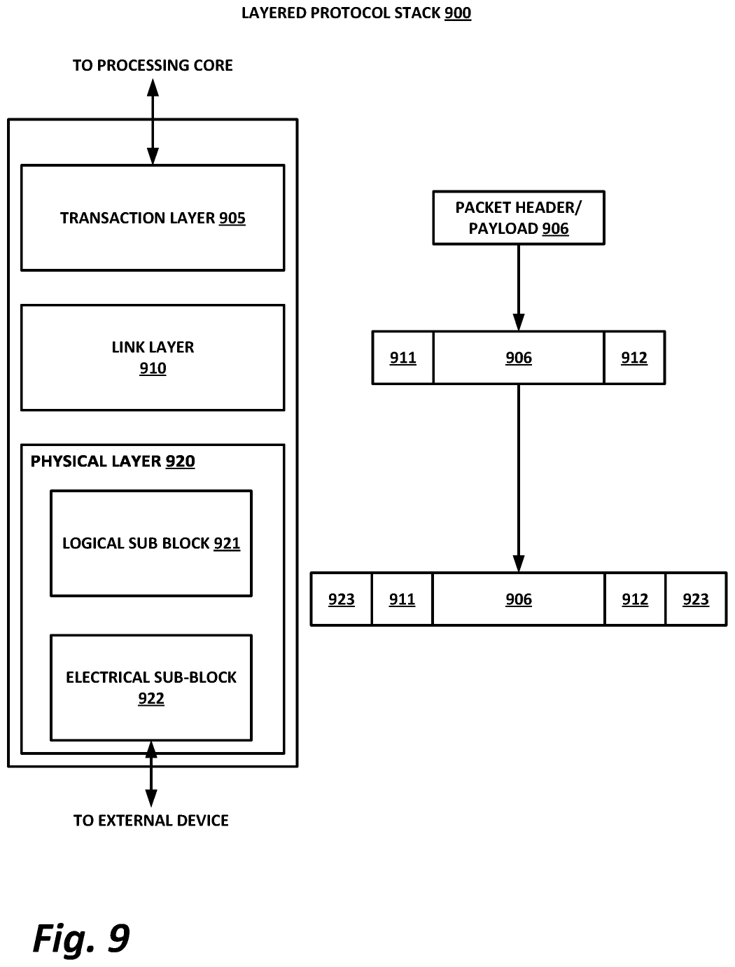

FIG. 10 illustrates an embodiment of a PCIe transaction descriptor, according to one or more examples of the present specification. The disclosed architecture of FIG. 10 may be provided in some embodiments with the PCIe chain descriptors of the present specification, and may benefit therefrom.

In one embodiment, transaction descriptor 1000 is a mechanism for carrying transaction information. In this regard, transaction descriptor 1000 supports identification of transactions in a system. Other potential uses include tracking modifications of default transaction ordering and association of transaction with channels.

Transaction descriptor 1000 includes global identifier field 1002, attributes field 1004 and channel identifier field 1006. In the illustrated example, global identifier field 1002 is depicted comprising local transaction identifier field 1008 and source identifier field 1010. In one embodiment, global transaction identifier 1002 is unique for all outstanding requests.

According to one implementation, local transaction identifier field 1008 is a field generated by a requesting agent, and it is unique for all outstanding requests that may require a completion for that requesting agent. Furthermore, in this example, source identifier 1010 uniquely identifies the requestor agent within a PCIe hierarchy. Accordingly, together with source ID 1010, local transaction identifier 1008 field provides global identification of a transaction within a hierarchy domain.

Attributes field 1004 specifies characteristics and relationships of the transaction. In this regard, attributes field 1004 is potentially used to provide additional information that allows modification of the default handling of transactions. In one embodiment, attributes field 1004 includes priority field 1012, reserved field 1014, ordering field 1016, and no-snoop field 1018. Here, priority subfield 1012 may be modified by an initiator to assign a priority to the transaction. Reserved attribute field 1014 is left reserved for future, or vendor-defined usage. Possible usage models using priority or security attributes may be implemented using the reserved attribute field.

In this example, ordering attribute field 1016 is used to supply optional information conveying the type of ordering that may modify default ordering rules. According to one example implementation, an ordering attribute of “0” denotes default ordering rules to apply, wherein an ordering attribute of “1” denotes relaxed ordering, writes can pass writes in the same direction, and read completions can pass writes in the same direction. Snoop attribute field 1018 is utilized to determine if transactions are snooped. As shown, channel ID field 1006 identifies a channel that a transaction is associated with.

Link Layer

Link layer 910, also referred to as data link layer 910, acts as an intermediate stage between transaction layer 905 and the physical layer 920. In one embodiment, a responsibility of the data link layer 910 is providing a reliable mechanism for exchanging transaction layer packets (TLPs) between two linked components. One side of the data link layer 910 accepts TLPs assembled by the transaction layer 905, applies packet sequence identifier 911, i.e., an identification number or packet number, calculates and applies an error detection code, i.e., CRC 912, and submits the modified TLPs to the physical layer 920 for transmission across a physical to an external device.

Physical Layer

In one embodiment, physical layer 920 includes logical sub-block 921 and electrical sub-block 922 to physically transmit a packet to an external device. Here, logical sub-block 921 is responsible for the “digital” functions of physical layer 921. In this regard, the logical sub-block includes a transmit section to prepare outgoing information for transmission by physical sub-block 922, and a receiver section to identify and prepare received information before passing it to the link layer 910.

Physical block 922 includes a transmitter and a receiver. The transmitter is supplied by logical sub-block 921 with symbols, which the transmitter serializes and transmits onto an external device. The receiver is supplied with serialized symbols from an external device and transforms the received signals into a bit-stream. The bit-stream is de-serialized and supplied to logical sub-block 921. In one embodiment, an 8b/10b transmission code is employed, where ten-bit symbols are transmitted/received. Here, special symbols are used to frame a packet with frames 923. In addition, in one example, the receiver also provides a symbol clock recovered from the incoming serial stream.

As stated above, although transaction layer 905, link layer 910, and physical layer 920 are discussed in reference to a specific embodiment of a PCIe protocol stack, a layered protocol stack is not so limited. In fact, any layered protocol may be included/implemented. As an example, a port/interface that is represented as a layered protocol includes: (1) a first layer to assemble packets, i.e., a transaction layer; a second layer to sequence packets, i.e., a link layer; and a third layer to transmit the packets, i.e., a physical layer. As a specific example, a common standard interface (CSI) layered protocol is utilized.

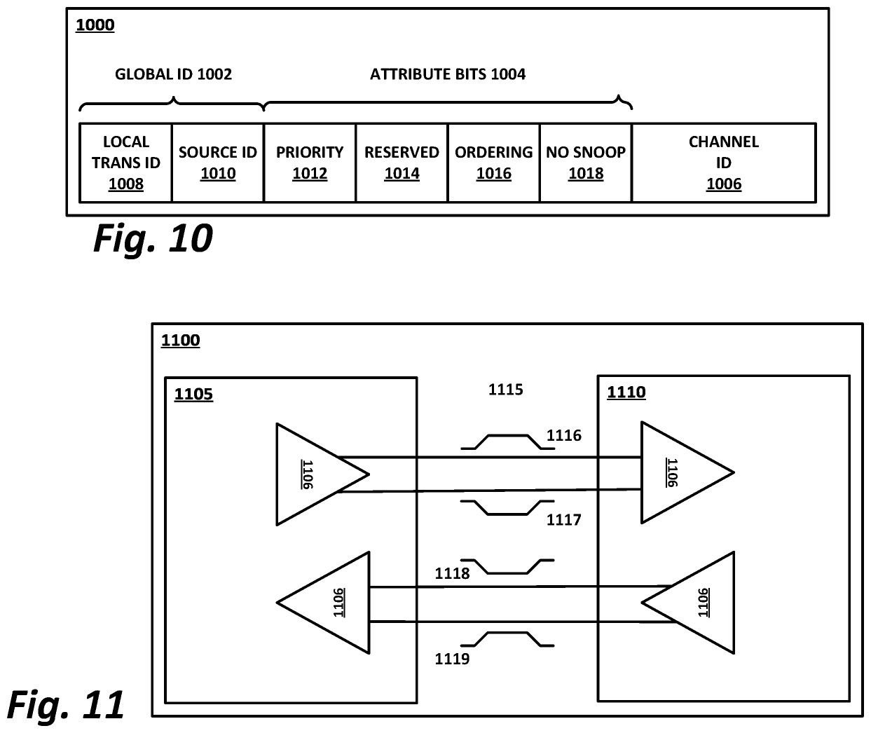

FIG. 11 illustrates an embodiment of a PCIe serial point-to-point fabric, according to one or more examples of the present specification. The disclosed architecture of FIG. 11 may be provided in some embodiments with the PCIe chain descriptors of the present specification, and may benefit therefrom.

Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 1106/1111 and a receive pair 1112/1107. Accordingly, device 1105 includes transmission logic 1106 to transmit data to device 1110 and receiving logic 1107 to receive data from device 1110. In other words, two transmitting paths, i.e., paths 1116 and 1117, and two receiving paths, i.e., paths 1118 and 1119, are included in a PCIe link.

A transmission path refers to any path for transmitting data, such as a transmission line, a copper line, an optical line, a wireless communication channel, an infrared communication link, or other communication path. A connection between two devices, such as device 1105 and device 1110, is referred to as a link, such as link 1115. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider.

A differential pair refers to two transmission paths, such as lines 1116 and 1117, to transmit differential signals. As an example, when line 1116 toggles from a low voltage level to a high voltage level, i.e., a rising edge, line 1117 drives from a high logic level to a low logic level, i.e., a falling edge. Differential signals potentially demonstrate better electrical characteristics, such as better signal integrity, i.e., cross-coupling, voltage overshoot/undershoot, ringing, etc. This allows for a better timing window, which enables faster transmission frequencies.

Note that the teachings of the chain descriptor of the present specification are distinguishable from certain existing technologies such as Direct Path and PCIe peer-to-peer (P2P) semantics.

In the case of Direct Path, endpoint-to-endpoint communication capability to offload memory movement overhead is employed. However, Direct Path is specifically intended for a network storage optimization with most of the software stack intact. In contrast, the chain descriptor of the present specification introduces a general descriptor unit to provide the flexibility for connections in a data center.

Embodiments of Direct Path focus specifically on a chain of two devices, with no provision for multiple hops. Thus, embodiments of Direct Path may not be usable in cases such as the one illustrated in FIG. 3 for a network crypto storage and process. Also note that in the case of Direct Path, the NIC issues two distinct DMA operations for each transaction. One moves the header to Intel® Architecture (IA) or to the processor for software processing, while the other directs data to the neighboring device.

Direct Path may rely on a standard network stack in Linux or some other operating system. Direct Path also provides a hardware stateless transaction. Exception and acknowledgment are handled individually on devices.

In contrast to Direct Path, the chain descriptor of the present specification provides for multiple hops. A compose request provided in a generalized descriptor unit (GDU) is forwarded to the next hop without software intervention. Thus, the NIC issues a DMA to the neighbor device only.

Further in contrast to Direct Path, embodiments of the present specification use a specialized software stack for the chained devices. In some cases, this may be targeted at a customized software stack such as Data Plane Development Kit (DPDK), and may bypass the regular kernel software stack to increase performance.

Further in contrast to Direct Path, the chain descriptor of the present specification provides a hardware stateful transaction. Most exception and acknowledge signals are transferred among chain devices, and are handled by the driver for the header device in the descriptor chain.

The chain descriptor of the present specification is also distinguishable from PCIe peer-to-peer (P2P) semantics. Embodiments of PCIe P2P combine multiple PCIe devices into one path and steer a payload to traverse them with a predefined configuration in the device.

Thus, some embodiments of PCIe P2P support only a single data path with a predefined rule. The user interface for PCIe P2P may support a post request only. This may require an application to manage heterogeneous device responses derived from the same request. Furthermore, a specific configuration may be configured on each device, without awareness of its neighbor devices.

In contrast to PCIe P2P, the chain descriptor of the present specification provides increased scalability. A single device can be shared among several data paths by provisioning multiple NAT entries. Dynamic routing information can be inferred from pointers inside the descriptors.

With respect to the user interface, non-posted requests may be directed to endpoints, so that applications interact with the head device only. This provides a transparent data path from the perspective of a user or programmer.

With respect to configuration, the chain descriptor of the present specification provides a consistent system configuration (e.g., with respect to routing information and QOS) over the chained devices once the NAT schema is defined. This enables ease of security control.

The foregoing outlines features of one or more embodiments of the subject matter disclosed herein. These embodiments are provided to enable a person having ordinary skill in the art (PHOSITA) to better understand various aspects of the present disclosure. Certain well-understood terms, as well as underlying technologies and/or standards may be referenced without being described in detail. It is anticipated that the PHOSITA will possess or have access to background knowledge or information in those technologies and standards sufficient to practice the teachings of the present specification.

The PHOSITA will appreciate that they may readily use the present disclosure as a basis for designing or modifying other processes, structures, or variations for carrying out the same purposes and/or achieving the same advantages of the embodiments introduced herein. The PHOSITA will also recognize that such equivalent constructions do not depart from the spirit and scope of the present disclosure, and that they may make various changes, substitutions, and alterations herein without departing from the spirit and scope of the present disclosure.

In the foregoing description, certain aspects of some or all embodiments are described in greater detail than is strictly necessary for practicing the appended claims. These details are provided by way of non-limiting example only, for the purpose of providing context and illustration of the disclosed embodiments. Such details should not be understood to be required, and should not be “read into” the claims as limitations. The phrase may refer to “an embodiment” or “embodiments.” These phrases, and any other references to embodiments, should be understood broadly to refer to any combination of one or more embodiments. Furthermore, the several features disclosed in a particular “embodiment” could just as well be spread across multiple embodiments. For example, if features 1 and 2 are disclosed in “an embodiment,” embodiment A may have feature 1 but lack feature 2, while embodiment B may have feature 2 but lack feature 1.

This specification may provide illustrations in a block diagram format, wherein certain features are disclosed in separate blocks. These should be understood broadly to disclose how various features interoperate, but are not intended to imply that those features must necessarily be embodied in separate hardware or software. Furthermore, where a single block discloses more than one feature in the same block, those features need not necessarily be embodied in the same hardware and/or software. For example, a computer “memory” could in some circumstances be distributed or mapped between multiple levels of cache or local memory, main memory, battery-backed volatile memory, and various forms of persistent memory such as a hard disk, storage server, optical disk, tape drive, or similar. In certain embodiments, some of the components may be omitted or consolidated. In a general sense, the arrangements depicted in the figures may be more logical in their representations, whereas a physical architecture may include various permutations, combinations, and/or hybrids of these elements. Countless possible design configurations can be used to achieve the operational objectives outlined herein. Accordingly, the associated infrastructure has a myriad of substitute arrangements, design choices, device possibilities, hardware configurations, software implementations, and equipment options.

References may be made herein to a computer-readable medium, which may be a tangible and non-transitory computer-readable medium. As used in this specification and throughout the claims, a “computer-readable medium” should be understood to include one or more computer-readable mediums of the same or different types. A computer-readable medium may include, by way of non-limiting example, an optical drive (e.g., CD/DVD/Blu-Ray), a hard drive, a solid-state drive, a flash memory, or other non-volatile medium. A computer-readable medium could also include a medium such as a read-only memory (ROM), an FPGA or ASIC configured to carry out the desired instructions, stored instructions for programming an FPGA or ASIC to carry out the desired instructions, an intellectual property (IP) block that can be integrated in hardware into other circuits, or instructions encoded directly into hardware or microcode on a processor such as a microprocessor, digital signal processor (DSP), microcontroller, or in any other suitable component, device, element, or object where appropriate and based on particular needs. A nontransitory storage medium herein is expressly intended to include any nontransitory special-purpose or programmable hardware configured to provide the disclosed operations, or to cause a processor to perform the disclosed operations.

Various elements may be “communicatively,” “electrically,” “mechanically,” or otherwise “coupled” to one another throughout this specification and the claims. Such coupling may be a direct, point-to-point coupling, or may include intermediary devices. For example, two devices may be communicatively coupled to one another via a controller that facilitates the communication. Devices may be electrically coupled to one another via intermediary devices such as signal boosters, voltage dividers, or buffers. Mechanically-coupled devices may be indirectly mechanically coupled.

Any “module” or “engine” disclosed herein may refer to or include software, a software stack, a combination of hardware, firmware, and/or software, a circuit configured to carry out the function of the engine or module, or any computer-readable medium as disclosed above. Such modules or engines may, in appropriate circumstances, be provided on or in conjunction with a hardware platform, which may include hardware compute resources such as a processor, memory, storage, interconnects, networks and network interfaces, accelerators, or other suitable hardware. Such a hardware platform may be provided as a single monolithic device (e.g., in a PC form factor), or with some or part of the function being distributed (e.g., a “composite node” in a high-end data center, where compute, memory, storage, and other resources may be dynamically allocated and need not be local to one another).

There may be disclosed herein flow charts, signal flow diagram, or other illustrations showing operations being performed in a particular order. Unless otherwise expressly noted, the order should be understood to be a non-limiting example only. Furthermore, in cases where one operation is shown to follow another, other intervening operations may also occur, which may be related or unrelated. Some operations may also be performed simultaneously or in parallel. In cases where an operation is said to be “based on” or “according to” another item or operation, this should be understood to imply that the operation is based at least partly on or according at least partly to the other item or operation. This should not be construed to imply that the operation is based solely or exclusively on, or solely or exclusively according to the item or operation.

All or part of any hardware element disclosed herein may readily be provided in a system-on-a-chip (SoC), including a central processing unit (CPU) package. An SoC represents an integrated circuit (IC) that integrates components of a computer or other electronic system into a single chip. Thus, for example, client devices or server devices may be provided, in whole or in part, in an SoC. The SoC may contain digital, analog, mixed-signal, and radio frequency functions, all of which may be provided on a single chip substrate. Other embodiments may include a multichip module (MCM), with a plurality of chips located within a single electronic package and configured to interact closely with each other through the electronic package.

In a general sense, any suitably-configured circuit or processor can execute any type of instructions associated with the data to achieve the operations detailed herein. Any processor disclosed herein could transform an element or an article (for example, data) from one state or thing to another state or thing. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, should be construed as being encompassed within the broad terms “memory” and “storage,” as appropriate.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. Any suitable processor and memory can be suitably coupled to the board based on particular configuration needs, processing demands, and computing designs. Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

### EXAMPLE IMPLEMENTATIONS

The following examples are provided by way of illustration.

Example 1 includes a computing apparatus, comprising: a hardware platform; an interface to a computer expansion bus; logic configured to operate on the hardware platform to: provision an unshaded memory queue, comprising a dedicated memory window for the computer expansion bus; and provision a descriptor ring, the descriptor ring configured to receive a descriptor, identify the descriptor as a chain descriptor targeted to a descriptor chain, identify a general descriptor unit (GDU) of the chain descriptor as having a device identifier (DID) matching the computing apparatus, process a workload of the GDU according to a private data field of the GDU, and forward the chain descriptor to a next-hop device via a switch fabric of the computer expansion bus, comprising bypassing a root complex of the computer expansion bus.

Example 2 includes the computing apparatus of example 1, wherein the logic is further to provision a neighbor address table (NAT) comprising mapping of DIDs to queue window addresses.

Example 3 includes the computing apparatus of example 2, wherein the NAT is a global NAT comprising mappings for a plurality of endpoint devices connected to the computer expansion bus.

Example 4 includes the computing apparatus of example 3, wherein the logic is to provision the NAT within a trusted environment.

Example 5 includes the computing apparatus of example 3, wherein the logic is further to runtime check the current and next pointer inside the descriptor to validate the DID, wherein the DID is validated only if it is consisted with a loaded NAT entry.

Example 6 includes the computing apparatus of example 1, wherein the logic is further to self-identify the computing apparatus as a header device of a descriptor chain, and retrieve workload data from memory via the root complex.

Example 7 includes the computing apparatus of example 6, wherein the header device is further to receive a completed workload in its response queue, write a response descriptor to memory, and write the completed workload to memory via the root complex.

Example 8 includes the computing apparatus of example 1, wherein the logic is further to receive a second descriptor, identify the second descriptor as a legacy descriptor, and to process the legacy descriptor without chaining.

Example 9 includes the computing apparatus of example 1, wherein the logic is further to ignore GDUs of the chain descriptor having a DID not matching the computing apparatus.

Example 10 includes the computing apparatus of example 1, wherein the logic is further to determine that the next-hop device for the chain descriptor is null, and to act as a terminal device in the descriptor chain.

Example 11 includes the computing apparatus of example 1, wherein the chain descriptor is a non-posted request to the computing apparatus.

Example 12 includes the computing apparatus of example 1, wherein the logic includes support for single-root input/output virtualization (SR-IOV) to provide input/output memory mapping unit (IOMMU) support, wherein the logic is configured to advertise the computing apparatus as a single apparatus supporting all functions of the descriptor chain.

Example 13 includes the computing apparatus of example 1, wherein the logic is configured to handle virtualized interrupt request and error reporting functions.

Example 14 includes the computing apparatus of example 1, wherein the logic is to provide an isolated base address register (BAR) for configuring a function of the computing apparatus.

Example 15 includes the computing apparatus of any of examples 1-14, wherein the expansion bus is a peripheral component interconnect express (PCIe) bus.

Example 16 includes one or more tangible, non-transitory computer-readable storage mediums having stored thereon logic to instruct a computing apparatus to: communicatively couple to a computer expansion bus; provision an unshaded memory queue, comprising a dedicated memory window for the computer expansion bus; and provision a descriptor ring, the descriptor ring configured to receive a descriptor, identify the descriptor as a chain descriptor targeted to a descriptor chain, identify a general descriptor unit (GDU) of the chain descriptor as having a device identifier (DID) matching the computing apparatus, process a workload of the GDU according to a private data field of the GDU, and forward the chain descriptor to a next-hop device via a switch fabric of the computer expansion bus, comprising bypassing a root complex of the computer expansion bus.

Example 17 includes the one or more tangible, non-transitory computer-readable storage mediums of example 16, wherein the logic is further to provision a neighbor address table (NAT) comprising mapping of DIDs to queue window addresses.

Example 18 includes the one or more tangible, non-transitory computer-readable storage mediums of example 17, wherein the NAT is a global NAT comprising mappings for a plurality of endpoint devices connected to the computer expansion bus.

Example 19 includes the one or more tangible, non-transitory computer-readable storage mediums of example 18, wherein the logic is to provision the NAT within a trusted environment.

Example 20 includes the one or more tangible, non-transitory computer-readable storage mediums of example 18, wherein the logic is further to runtime check the current and next pointer inside the descriptor to validate the DID, wherein the DID is validated only if it is consisted with a loaded NAT entry.

Example 21 includes the one or more tangible, non-transitory computer-readable storage mediums of example 16, wherein the logic is further to self-identify the computing apparatus as a header device of a descriptor chain, and retrieve workload data from memory via the root complex.

Example 22 includes the one or more tangible, non-transitory computer-readable storage mediums of example 21, wherein the header device is further to receive a completed workload in its response queue, write a response descriptor to memory, and write the completed workload to memory via the root complex.

Example 23 includes the one or more tangible, non-transitory computer-readable storage mediums of example 16, wherein the logic is further to receive a second descriptor, identify the second descriptor as a legacy descriptor, and to process the legacy descriptor without chaining.

Example 24 includes the one or more tangible, non-transitory computer-readable storage mediums of example 16, wherein the logic is further to ignore GDUs of the chain descriptor having a DID not matching the computing apparatus.

Example 25 includes the one or more tangible, non-transitory computer-readable storage mediums of example 16, wherein the logic is further to determine that the next-hop device for the chain descriptor is null, and to act as a terminal device in the descriptor chain.

Example 26 includes the one or more tangible, non-transitory computer-readable storage mediums of example 16, wherein the chain descriptor is a non-posted request to the computing apparatus.

Example 27 includes the one or more tangible, non-transitory computer-readable storage mediums of example 16, wherein the logic includes support for single-root input/output virtualization (SR-IOV) to provide input/output memory mapping unit (IOMMU) support, wherein the logic is configured to advertise the computing apparatus as a single apparatus supporting all functions of the descriptor chain.

Example 28 includes the one or more tangible, non-transitory computer-readable storage mediums of example 16, wherein the logic is configured to handle virtualized interrupt request and error reporting functions.

Example 29 includes the one or more tangible, non-transitory computer-readable storage mediums of example 16, wherein the logic is to provide an isolated base address register (BAR) for configuring a function of the computing apparatus.

Example 30 includes the one or more tangible, non-transitory computer-readable storage mediums of any of examples 16-29, wherein the expansion bus is a peripheral component interconnect express (PCIe) bus.

Example 31 includes a computer-implemented method of providing chained operations on a computer expansion bus, comprising: communicatively coupling to the computer expansion bus; provisioning an unshaded memory queue, comprising a dedicated memory window for the computer expansion bus; and provisioning a descriptor ring, the descriptor ring configured to receive a descriptor, identify the descriptor as a chain descriptor targeted to a descriptor chain, identify a general descriptor unit (GDU) of the chain descriptor as having a device identifier (DID) matching the computing apparatus, process a workload of the GDU according to a private data field of the GDU, and forward the chain descriptor to a next-hop device via a switch fabric of the computer expansion bus, comprising bypassing a root complex of the computer expansion bus.

Example 32 includes the method of example 31, further comprising provisioning a neighbor address table (NAT) comprising mapping of DIDs to queue window addresses.

Example 33 includes the method of example 31, wherein the NAT is a global NAT comprising mappings for a plurality of endpoint devices connected to the computer expansion bus.

Example 34 includes the method of example 33, further comprising provisioning the NAT within a trusted environment.

Example 35 includes the method of example 34, further comprising runtime checking the current and next pointer inside the descriptor to validate the DID, wherein the DID is validated only if it is consisted with a loaded NAT entry.

Example 36 includes the method of example 31, further comprising self-identifying the computing apparatus as a header device of a descriptor chain, and retrieve workload data from memory via the root complex.

Example 37 includes the method of example 36, further comprising receiving a completed workload in its response queue, write a response descriptor to memory, and write the completed workload to memory via the root complex.

Example 38 includes the method of example 31, further comprising receiving a second descriptor, identify the second descriptor as a legacy descriptor, and to process the legacy descriptor without chaining.

Example 39 includes the method of example 31, further comprising ignoring GDUs of the chain descriptor having a DID not matching the computing apparatus.

Example 40 includes the method of example 31, further comprising determining that the next-hop device for the chain descriptor is null, and to act as a terminal device in the descriptor chain.

Example 41 includes the method of example 31, wherein the chain descriptor is a non-posted request to the computing apparatus.

Example 42 includes the method of example 31, further comprising providing support for single-root input/output virtualization (SR-IOV) to provide input/output memory mapping unit (IOMMU) support, and advertising the computing apparatus as a single apparatus supporting all functions of the descriptor chain.

Example 43 includes the method of example 31, further comprising handling virtualized interrupt request and error reporting functions.

Example 44 includes the method of example 31, further comprising providing an isolated base address register (BAR) for configuring a function of the computing apparatus.

Example 45 includes the method of any of examples 31-44, wherein the expansion bus is a peripheral component interconnect express (PCIe) bus.

Example 46 includes an apparatus comprising means for performing the method of any of examples 31-45.

Example 47 includes the apparatus of example 46, wherein the means for performing the method comprise a processor and a memory.

Example 48 includes the apparatus of example 47, wherein the memory comprises machine-readable instructions, that when executed cause the apparatus to perform the method of any of examples 31-45.

Example 49 includes the apparatus of any of examples 46-48, wherein the apparatus is a computing system.

Example 50 includes at least one computer readable medium comprising instructions that, when executed, implement a method or realize an apparatus as illustrated in any of examples 31-49.

Example 51 includes a computer-implemented method of operating a descriptor chain via a computer expansion bus, comprising: enumerating a plurality of endpoint devices via the computer expansion bus; loading drivers for the plurality of endpoint devices; building a chain descriptor employing the plurality of endpoint devices, the chain descriptor comprising a plurality of generalized descriptor units (GDUs), the GDUs comprising a device identifier (DID), a next-hop pointer, and a private data field; identifying a header device of the descriptor chain; and exporting the chain descriptor to the header device via a root complex of the computer expansion bus.

Example 52 includes the method of example 51, wherein the computer expansion bus is a peripheral component interconnect express (PCIe) bus.

Example 53 includes an apparatus comprising means for performing the method of any of examples 51-52.

Example 54 includes the apparatus of example 53, wherein the means for performing the method comprise a processor and a memory.

Example 55 includes the apparatus of example 54, wherein the memory comprises machine-readable instructions, that when executed cause the apparatus to perform the method of any of examples 51-52.

Example 56 includes the apparatus of any of examples 53-55, wherein the apparatus is a computing system.

Example 57 includes at least one computer readable medium comprising instructions that, when executed, implement a method or realize an apparatus as illustrated in any of examples 51-56.

1. A computing apparatus, comprising:
a hardware platform;
an interface to a computer expansion bus;
logic configured to operate on the hardware platform to:
provision an unshaded memory queue, comprising a dedicated memory window for the computer expansion bus; and
provision a descriptor ring, the descriptor ring configured to receive a descriptor, identify the descriptor as a chain descriptor targeted to a descriptor chain, identify a general descriptor unit (GDU) of the chain descriptor as having a device identifier (DID) matching the computing apparatus, process a workload of the GDU according to a private data field of the GDU, and forward the chain descriptor to a next-hop device via a switch fabric of the computer expansion bus, comprising bypassing a root complex of the computer expansion bus.

2. The computing apparatus of claim 1, wherein the logic is further to provision a neighbor address table (NAT) comprising mapping of DIDs to queue window addresses.

3. The computing apparatus of claim 2, wherein the NAT is a global NAT comprising mappings for a plurality of endpoint devices connected to the computer expansion bus.

4. The computing apparatus of claim 3, wherein the logic is to provision the NAT within a trusted environment.

5. The computing apparatus of claim 3, wherein the logic is further to runtime check a current and next pointer inside the descriptor to validate the DID, wherein the DID is validated only if it is consisted with a loaded NAT entry.

6. The computing apparatus of claim 1, wherein the logic is further to self-identify the computing apparatus as a header device of a descriptor chain, and retrieve workload data from memory via the root complex.

7. The computing apparatus of claim 6, wherein the header device is further to receive a completed workload in its response queue, write a response descriptor to memory, and write the completed workload to memory via the root complex.

8. The computing apparatus of claim 1, wherein the logic is further to receive a second descriptor, identify the second descriptor as a legacy descriptor, and to process the legacy descriptor without chaining.

9. The computing apparatus of claim 1, wherein the logic is further to ignore GDUs of the chain descriptor having a DID not matching the computing apparatus.

10. The computing apparatus of claim 1, wherein the logic is further to determine that the next-hop device for the chain descriptor is null, and to act as a terminal device in the descriptor chain.

11. The computing apparatus of claim 1, wherein the chain descriptor is a non-posted request to the computing apparatus.

12. The computing apparatus of claim 1, wherein the logic includes support for single-root input/output virtualization (SR-IOV) to provide input/output memory mapping unit (IOMMU) support, wherein the logic is configured to advertise the computing apparatus as a single apparatus supporting all functions of the descriptor chain.

13. The computing apparatus of claim 1, wherein the logic is configured to handle virtualized interrupt request and error reporting functions.

14. The computing apparatus of claim 1, wherein the logic is to provide an isolated base address register (BAR) for configuring a function of the computing apparatus.

15. The computing apparatus of claim 1, wherein the computer expansion bus is a peripheral component interconnect express (PCIe) bus.

16. One or more tangible, non-transitory computer-readable storage mediums having stored thereon logic to instruct a computing apparatus to:
communicatively couple to a computer expansion bus;
provision an unshaded memory queue, comprising a dedicated memory window for the computer expansion bus; and
provision a descriptor ring, the descriptor ring configured to receive a descriptor, identify the descriptor as a chain descriptor targeted to a descriptor chain, identify a general descriptor unit (GDU) of the chain descriptor as having a device identifier (DID) matching the computing apparatus, process a workload of the GDU according to a private data field of the GDU, and forward the chain descriptor to a next-hop device via a switch fabric of the computer expansion bus, comprising bypassing a root complex of the computer expansion bus.

17. (canceled)

18. (canceled)

19. (canceled)

20. (canceled)

21. (canceled)

22. The one or more tangible, non-transitory computer-readable storage mediums of claim 16 wherein a header device is to receive a completed workload in its response queue, write a response descriptor to memory, and write the completed workload to memory via the root complex.

23. The one or more tangible, non-transitory computer-readable storage mediums of claim 16, wherein the expansion bus is a peripheral component interconnect express (PCIe) bus.

24. A computer-implemented method of operating a descriptor chain via a computer expansion bus, comprising:
enumerating a plurality of endpoint devices via the computer expansion bus;
loading drivers for the plurality of endpoint devices;
building a chain descriptor employing the plurality of endpoint devices, the chain descriptor comprising a plurality of generalized descriptor units (GDUs), the GDUs comprising a device identifier (DID), a next-hop pointer, and a private data field;
identifying a header device of the descriptor chain; and
exporting the chain descriptor to the header device via a root complex of the computer expansion bus.

25. The method of claim 24, wherein the computer expansion bus is a peripheral component interconnect express (PCIe) bus.
